(19) United States
(12) Patent Application Publication
(10) Pub. No.: US 2026/0318301 A1
(43) Pub. Date: Oct. 15, 2026

(54) ELECTRO-HYDRAULIC CLOSED LOOP ZERO EMISSIONS VALVE ACTUATION SYSTEM

(71) Applicant: Newton Valve Actuation Systems LLC, Waller, TX (US)

(72) Inventors: Ben Cusack, Cypress, TX (US); Kevin Johnson, Houston, TX (US); Mark Finley, Cypress, TX (US)

(73) Assignee: Newton Valve Actuation Systems LLC, Waller, TX (US)

(21) Appl. No.: 19/464,126

(22) Filed: Jan. 29, 2026

Related U.S. Application Data
(60) Provisional application No. 63/752,045, filed on Jan. 31, 2025.

(51) Int. Cl. F04C 28/00; F04B 17/03; F04B 49/12; F04C 2/08; F04C 29/00

(52) U.S. Cl. CPC F04C 28/00; F04B 17/03; F04B 49/125; F04C 2/084; F04C 29/0085; F04C 2240/40

(57) ABSTRACT

In general, in one aspect, examples relate to a system, that comprises a housing, a manifold block, a motor in energetic communication with the manifold block, and a spring accumulator in fluid communication with the manifold block. Moreover, the system may be configured for actuating. In examples, actuating is performed via a gear pump or a multi-pump manifold block.

### BACKGROUND

Valves are commonly used in various industries to control the flow of fluid, e.g., oil and gas, through pipelines. A valve actuator may be positioned near a flowline at the valve to open and close the valve. Common types of valve actuators comprise manual, pneumatic, hydraulic, electric, and spring actuators. Process control automation often uses electronically controlled valve actuators. In many installations, valve actuators are expected to operate continuously or intermittently over long service intervals, often without direct human supervision. Such actuators may be installed in locations that are difficult to access, including remote, outdoor, or hazardous environments. Accordingly, actuator reliability and predictable performance are important considerations in the design and operation of fluid control systems. Electronically controlled valve actuators are frequently coupled to control systems that enable automated operation and remote control of the valve position based on process conditions.

Valve actuation systems are sometimes susceptible to particulate contamination and corrosion and other problems. For example, seals can degrade or become damaged, resulting in leaks, pressure loss, or inefficiency. Exposure to corrosive environments can negatively affect the lifespan and efficiency of an actuator, as can extreme temperatures, humidity, weather, etc. In addition to environmental exposure, actuator components may experience wear due to repeated actuation cycles and fluctuating operating conditions. Over time, such wear can reduce performance margins and increase the likelihood of malfunction. In automated systems, degradation of actuator components may not be immediately apparent and can lead to inaccurate valve positioning or delayed response.

Further, overloading which is excessive torque applied to the actuator beyond a design limit may damage the internal components of an actuator and result in mechanical failure. Hydraulic valve actuators in particular often require regular maintenance, and this results in nonproductive time (NPT) while the valve is being serviced. Maintenance-related downtime can interrupt normal operations and may require isolation of the valve or associated flowline. In some cases, servicing an actuator involves disassembly, fluid replacement, or seal repair, which can increase labor requirements and operational costs. Repeated maintenance events may also increase the risk of installation errors or additional component wear. Furthermore, actuators that use reservoirs are vulnerable to particulate contamination as well as the unwanted introduction of water condensation into, e.g., oil or gas flowing through a pipeline. Contamination or moisture ingress can degrade actuator performance and contribute to corrosion or blockage within the system. These conditions can shorten service life and reduce operational reliability, particularly in applications where consistent valve actuation is required.

As such, actuators are subject to wear, contamination, corrosion, and environmental exposure, which can degrade seals, reduce efficiency, and impair reliable operation. Excessive loading and maintenance requirements, particularly in hydraulic systems, can lead to mechanical failure and nonproductive time. Additionally, reservoir-based actuators are vulnerable to particulate and moisture ingress, further reducing actuator lifespan and system reliability. When actuators fail for these reasons, there are financial consequences and valuable resources may be wasted or not fully appreciated. There is a need for more sustainable actuator designs.

### BRIEF DESCRIPTION OF THE DRAWINGS

These drawings illustrate certain aspects of some of the examples of the present invention and should not be used to limit or define the invention.

FIG. 1 illustrates a schematic of a valve actuation system mounted on an actuator connected to a flowline in accordance with some embodiments of the present disclosure.

FIG. 2 illustrates a schematic of the valve actuation system of FIG. 1 but mounted on a skid proximate to a flowline, in accordance with some embodiments of the present disclosure.

FIG. 3 illustrates a schematic of the valve actuation system of FIGS. 1 and 2, in accordance with some embodiments of the present disclosure.

FIG. 4 illustrates a spring accumulator, in accordance with some embodiments of the present disclosure.

FIG. 5 illustrates a position indication rod having a stud with a chamfered surface, in accordance with some embodiments of the present disclosure.

FIG. 6 illustrates a control circuit for controlling the valve actuation system of FIGS. 1-4, in accordance with some embodiments of the present disclosure.

FIG. 7 illustrates hydraulic circuit.

FIG. 8A illustrates multi-pump manifold block.

FIG. 8B illustrates pump elements.

FIG. 8C illustrates pump housing cavity.

FIG. 8D illustrates shaft extension.

FIG. 8E illustrates multi-pump manifold block with bearing to carry shaft extension;

FIG. 8F illustrates, spring return (single acting) multi-pump circuit.

FIG. 8G illustrates another example of multi-pump circuit with additional valves.

### DETAILED DESCRIPTION

Disclosed herein are systems and methods for valve automation, and, more particularly, disclosed is a closed loop, electro-hydraulic valve actuation system that comprises a spring accumulator and a pump. The electro-hydraulic valve actuation may be disposed, for example, on or at a flowline such as an oil and gas pipeline and thus be configured d to open and close a valve of the flowline. In such configurations, the electro-hydraulic valve actuation system may be configured to provide controlled and repeatable valve movement while maintaining system pressure within defined operating limits. The closed-loop arrangement may allow hydraulic fluid to be circulated internally during operation, thereby enabling precise control of valve position and actuation force. The spring accumulator may store mechanical energy to assist with valve movement, including during loss of external power or transient operating conditions, while the pump may be selectively energized to recharge or maintain system pressure as needed.

The valve actuation system of the present disclosure may be characterized by reduced NPT due to its being, in some examples, a reservoir-less system. Contamination by particulates and/or water condensate into the flowline may be prevented or reduced due to the system's being, e.g. contained within in a closed environment containing a spring accumulator in fluid communication with a pump disposed within a manifold block and connected to an electric motor. By eliminating or reducing reliance on an external hydraulic reservoir, the system may reduce opportunities for fluid contamination and simplify maintenance procedures. The closed environment may further limit exposure of hydraulic components to ambient conditions, thereby improving reliability and extending service intervals. The integration of the spring accumulator, pump, and manifold block may also reduce system complexity and overall footprint, facilitating installation in space-constrained or remote locations.

In addition, this system may be disposed in a housing. The housing may further contain various other components such as pressure switches and a solenoid valve which may be, in some examples, explosion proof. A manual override, or hydraulic handpump, may also be contained within the housing, as well as a motor starter box, which may also be explosion proof. This may allow for an operator to bypass a solenoid valve, e.g., during maintenance. The system may further comprise a relief valve proximate or adjacent to the handpump. The inclusion of such components within a common housing may provide environmental protection and facilitate safer operation in hazardous locations. The manual override may allow continued valve operation in the event of electrical failure or during servicing, while the relief valve may protect the system from overpressure conditions. Locating these elements within the housing may also simplify installation and reduce the need for external plumbing or wiring.

In addition, a control mechanism such as electronics may be contained within the housing and may be in wired or wireless communication with an internal or external control system which may comprise, e.g., a touchscreen human machine interface (HMI) and/or smart relay equipment such as relays and timers. Such control mechanisms may enable automated operation, status monitoring, and fault detection of the valve actuation system. Communication with external control systems may allow integration into broader process control architectures, enabling coordinated operation with other equipment and providing operators with real-time feedback regarding actuator performance and system conditions. In general, however, the valve actuation system may comprise a housing that houses an electric motor, explosion proof components that comprise a pressure switch and low-leak solenoid valve, a spring accumulator, a manifold block, and a hydraulic handpump. Advantageously, the system may be mounted directly on a pipeline, valve, or actuator, or else, e.g., on a skid mount proximate or adjacent to a flowline. In this manner, the valve actuation system may control actuation of one or more valves and thus flow through the flowline based on autonomous internal processing, external processing, and/or human interactions with an HMI or other suitable device in communication with the valve actuation system.

The systems and methods of the present disclosure may have the advantage of reducing particulate contamination and preventing condensation of water into oil. This may have improved lifespan and efficiency while reducing maintenance downtime. Other improvements may comprise, without limitation, zero or reduced carbon emissions (e.g., meeting ESG requirements), standardized design and modular components, multi-functionality (e.g., a mechanical fail safe), low power consumption (e.g., operating with simple UPS backups or utility power), and a reduced need for complicated infrastructure and/or installation (e.g., UL certified hazard area rated).

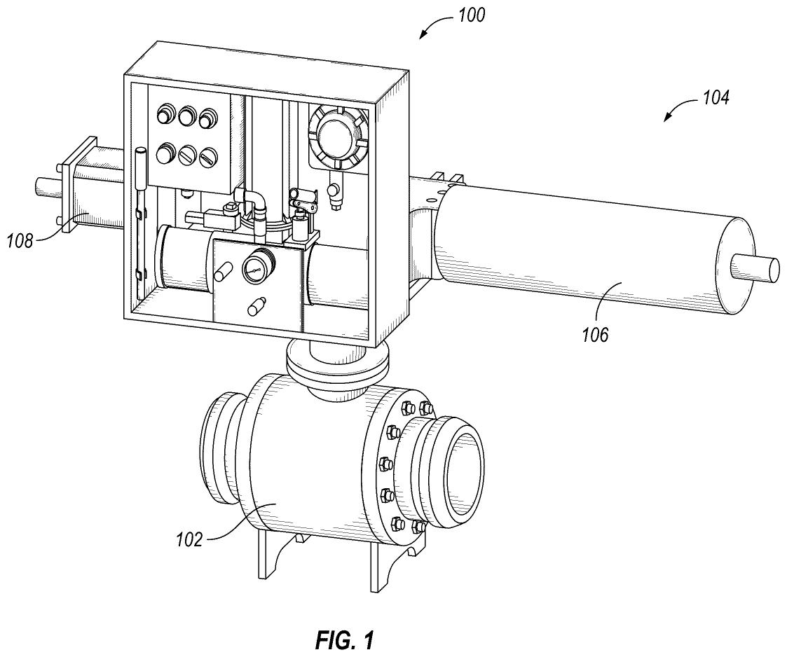

FIG. 1 shows a schematic of a pumping system 100 at or near flowline 102. As illustrated, pumping system 100 may be mounted (e.g., directly) to an actuator 104 which may in turn be coupled to and configured d to actuate a valve of the flowline 102. As discussed, pumping system 100 is a valve actuation system that may comprise an electric motor, explosion proof components, a manifold block, a spring accumulator, and a hydraulic handpump.

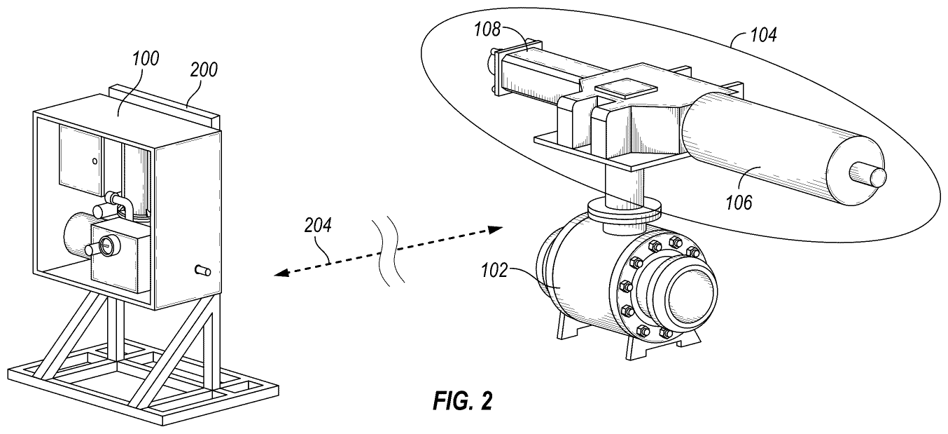

Alternatively, FIG. 2 shows that pumping system 100 may be mounted on a skid 200 which is in turn positioned near or at the flowline 102 such that, by means of actuation of actuator 104 using a connection 202 between pumping system 100 and actuator 104, a valve position and thus flow of fluid through flowline 102 is controlled by the pumping system 100, e.g., the valve may be open and closed. FIGS. 1 and 2 also show actuator spring-canister 106 and hydraulic cylinder 108 forming part of actuator 104. As with FIG. 1, pumping system 100 is a valve actuation system that is configured d to actuate a valve of the flowline 102.

As mentioned, pumping system 100 may be characterized as a “closed loop” system, meaning that it is a reservoir-less system. As a result, pumping system 100 may decrease particulate contamination and prevent water condensation into oil as compared to standard equipment involving reservoirs. Moreover, lifespan and efficiency of pumping system 100 may be improved relative to comparable devices in the industry, while reducing the need for maintenance and thus lowering the amount of non-productive downtime (NPT).

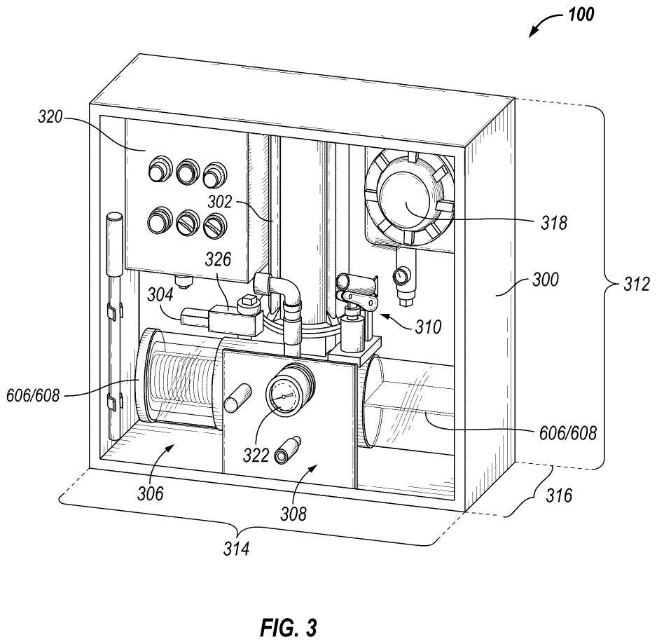

FIG. 3 shows a schematic of pumping system 100 in more detail, in accordance with some examples of the present disclosure. Pumping system 100 may comprise a housing 300, an electric motor 302, explosion proof components 304, spring accumulator 606/608, manifold block 308, and manual override 310. One or more, e.g., all, of these subcomponents or subassemblies of pumping system 100 may be enclosed by housing 300. For example, housing 300 is shown as housing electric motor 302, explosion proof components 304, spring accumulator 606/608, manifold block 308, and manual override 310.

Housing 300 may have any suitable dimensions to accommodate the one or more system components disposed therein. For example, housing 300 may have a length 312 of 24″, a width 314 of 24″, and a depth 316 of about 13″. Alternatively, a length 312 between 16″ and 40″, a width 314 between 16″ and 40″, and a depth 316 between 8″ and 30″, or any respective ranges therebetween.

Attached to housing 300 may be various control packages, such as a touchscreen HMI and/or a programmable controller configured to replace multiple timers, relays, and/or counters. Where used, a touchscreen HMI controls actuation of a valve for electric motor 302 of flowline 102 (e.g., referring to FIG. 1) using pumping system 100. Further, a user may customize user setting of pumping system 100 via touchscreen HMI, which may be MODBUS compatible or otherwise in communication with one or more buses and a network. One or more smart relays or comparable devices may further be used to control operations of pumping system 100 via, e.g., pushbuttons and selector switches. Where used, the various control packages and their associated electronics may be used to monitor, control, regulate, convey, remotely access, receive, and/or relay, the parameters, information, measurements, instructions, etc., associated with pumping system 100.

Electric motor 302 is housed within housing 300 and is energetically/mechanically coupled to, e.g., a positive displacement pump (e.g. gear pump) disposed within manifold block 308. Electric motor 302 may be explosion-proof, and may be directly mounted to manifold block 308, in some examples. Electric motor 302 may be, for example, a high voltage (HV), extra-high voltage (EHV), ultra-high voltage (UHV), or medium voltage (MV) motor. Electric motor 302 may have a direct current (VDC) voltage rating between, for example, 24 DC and 240 DC, alternating current voltage single phase (1Ph): 110 VAC 1Ph-220 VAC 1Ph, alternating current voltage (VAC) three phase (3Ph): 220 VAC 3Ph-480 VAC 3Ph, alternatively, an alternating current voltage (VAC) single phase (1 Ph) rating between, for example, 110 VAC 1Ph and 220 VAC 1PH, or any ranges therebetween, or alternatively, a VAC three phase (3Ph) rating between, for example, 220 VAC 3Ph and 480 VAC 3Ph, or any ranges therebetween. In operation, electric motor 302 turns a rotor which in turn drives fluid displacement through the pump, e.g., by forcing the rotation of gears of a gear pump.

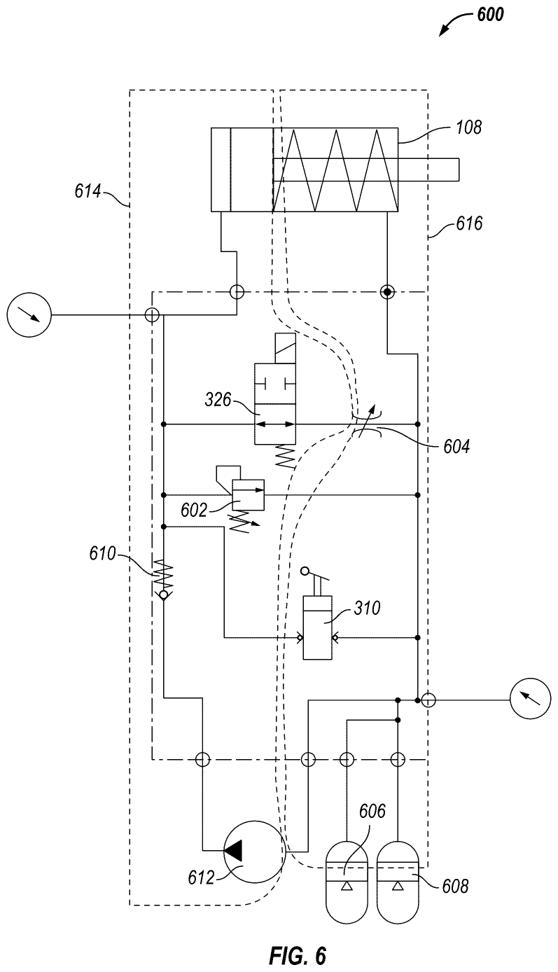

Manifold block 308 may be designed, in some examples, for high efficiency power transmission. Further, manifold block 308 may house one or more components (e.g., gears) of the system's pump. A pump may be, for example, a positive displacement pump such as a rotary-type positive displacement pump (e.g., gear pump 612 of FIG. 6). As illustrated, electric motor 302 may be mounted to the manifold block 308 or else configured d in an equivalent manner to impart rotational energy to a portion of the pump contained within manifold block 308 to drive fluid displacement and thereby increase hydraulic pressure within spring accumulator 606/608, to be discussed in greater detail. Additionally, spring accumulator 606/608 may also be connected to the manifold block 308 and thus may be in fluid/pressure communication with the pump. As mentioned, a gear pump may be located inside the manifold block 308.

Manifold block 308 may use a needle valve 324 for monitoring and/or controlling flow rates of fluid through manifold block 308. Needle valve 324 may be configured d in any suitable fashion and may, e.g., use a small cylindrical port with a needle shaped plunger. Control of fluid flow through manifold block 308 may be monitored and/or regulated using a spindle, in some examples. For example, a needle shaped plunger may retract to allow for precise control of fluid flow at low pressures. Additionally, manifold block 308 may use a pressure gauge 322 to monitor pressure within manifold block 308 and display pressure measurements to an operator of pumping system 100.

As mentioned, explosion proof components 304 may comprise a pressure switch and a solenoid valve 326. A solenoid valve 326 may be characterized as a “low leak” valve. Solenoid valve 326 is actuated via energizing of an electro-magnetic coil. In examples, solenoid valve 326 blocks flow when the coil is energized. Upon loss of power to the coil, solenoid valve 326 will mechanically close. When solenoid valve 326 is open, fluid passes through it, and this relieves pressure from hydraulic cylinder 108. In examples, energizing of a solenoid coil of solenoid valve 326 may be controlled via an output from a programmable logic controller. In certain examples, solenoid valve 326 may be used to change the direction of flow, for example, by changing between an “open” or “close” side of spring accumulator 606/608 or hydraulic cylinder 306, (e.g., referring to FIG. 3). Solenoid valve 326 may be actuated via energizing an electro-magnetic coil. In examples, solenoid valve 326 may block flow when the coil is energized. Upon loss of power, or disconnecting power to solenoid coil 326 it may mechanically close. In this example, when solenoid valve 326 is open fluid may pass through it, and this is used to relieve pressure from hydraulic cylinder 306. Energizing solenoid coil 326 may be controlled via an output from the PLC.

In some cases solenoid valves can be used to change the direction of flow, for example to direction fluid to the “open” or “close” side of a double acting cylinder. Further, a pressure switch (not shown), which may alternatively comprise a pressure transmitter rather than a switch in some examples, may be used to monitor a pressure in hydraulic cylinder 108 (e.g., referring to FIGS. 1, 2, 6). If pressure drops below a predetermined point, a control system may turn on electric motor 302, thereby using a hydraulic pump to build more pressure to maintain a desired pressure. Maintaining a desired pressure level within hydraulic cylinder 108 is important, as it ensures that actuator 104 does not inadvertently revert to a closed position. In examples, the pressure switch monitors the pressure in the hydraulic cylinder 306. If the pressure drops below a determined point the control system will turn on the electric motor, thus using the hydraulic pump to build more pressure to maintain the desired level. Maintaining the desired pressure level is important as it ensures that the actuator does not start to move to the “close” position.

Motor starter box 318 is housed within housing 300 and is energetically coupled to electric motor 302. Motor starter box 318 may be used to start, stop, or otherwise supply power pulses to electric motor 302. Any suitable type of motor starter box 318 may be used, for example, one that comprises a contactor and an overload relay disposed within a housing that, as shown, may be disposed within housing 300. A contactor of motor starter box 318 may control a flow of electric current to electric motor 302 and, once the electric motor 302 is activated, the contactor may close, thereby allowing electric current to flow from a power source (e.g., originating from outside of housing 300) to the electric motor 302. The overload relay may monitor current flowing to electric motor 302 and prevent damage to electric motor 302 by opening a circuit and thereby stopping flow of electricity when current exceeds a threshold level. Motor starter box 318 comprise, for example, one or more fuses, circuit breakers, or other control circuitry, and may be equipped to be remotely operated and/or automated, e.g., via a wired or wireless connection to one or more of the various control packages mentioned above.

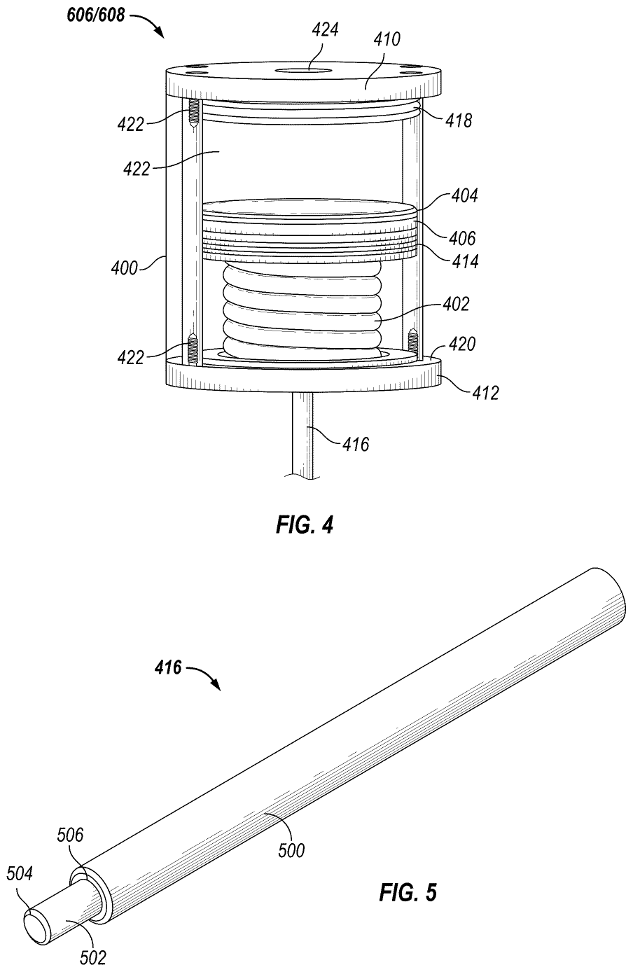

Spring accumulator 606/608 may be likewise affixed or otherwise mechanically coupled to one or more components of manifold block 308. Spring accumulator 606/608 may comprise dual low-pressure accumulators that store excess oil for cylinder rod displacement. Spring accumulator 606/608 may be any suitable type of spring accumulator (e.g., a JuicePak™ spring accumulator), and may comprise, for example, a fluid chamber and a mechanical spring, to be discussed in greater detail in FIG. 4.

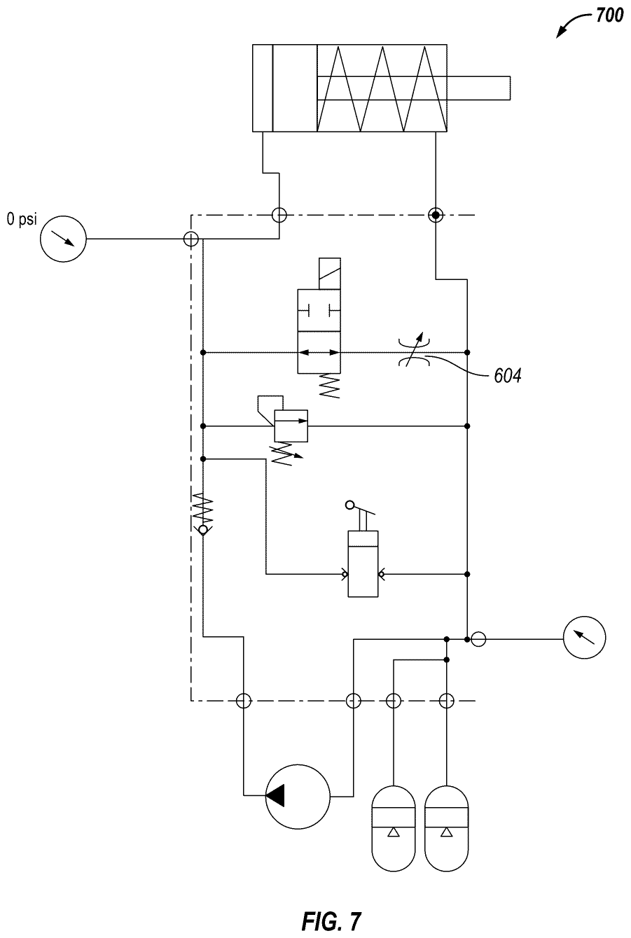

Manual override 310 is a mechanism (e.g., hydraulic handpump) that serves to manually override solenoid valve 326. The manual override 310, when operated, bypasses the solenoid in operation, such as when it is desired to perform maintenance on pumping system 100. Hydraulic hand pump 310 may be utilized by local (on-site) operators to manually operate the valve in cases of loss/absence of power or remote power lockout. In cases of loss/absence of power needle valve 604 (e.g., referring to FIG. 7) must closed to allow pressure to be built in hydraulic cylinder 306. Opening the needle valve 604 releases pressure, allowing the valve of a flowline 102 (e.g., referring to FIG. 1), in an example, to close. The hydraulic handpump, in coordination with needle valve 604, “bypasses” the solenoid valve 326 in that the solenoid valve doesn't require power for the manual override to function. Manual override 310 does bypass the gear pump 302. The hydraulic handpump may be used, in coordination with the solenoid valve 326 and/or the needle valve 604, to operate the system while the electric motor is broken or removed.

Manual override 310 may be utilized by local (on-site) operators to manually operate the valve in the event of power loss or remote power lockout, for example. In the event of power loss, a needle valve (e.g., needle valve 604 of FIG. 6) may close, thereby allowing pressure to build within hydraulic cylinder 306. Opening needle valve 604 releases pressure, thereby allowing valve 104 (e.g., referring to FIGS. 1, 2) to close. Thus, manual override 310, in coordination with needle valve 604, bypasses solenoid valve 326 so that solenoid valve 326 may be operated without power. Furthermore, manual override 310 may also bypass a gear pump (e.g., gear pump 612 of FIG. 6).

Relief valve 602 (e.g., referring to FIG. 6) may also be located at any suitable location within housing 300, e.g., behind the manual override 310. Where used, a relief valve may release pressure before the temperature and pressure build up in the manifold block 308.

FIG. 4 illustrates a spring accumulator 606/608, in accordance with some examples of the present disclosure. As mentioned, spring accumulator 606/608 may comprise a cylindrical body (e.g., comprising aluminum) that comprises a fluid chamber 400 having a spring 402 disposed therein. In general, spring accumulator 606/608 may comprise a spring 402 and a piston 404 disposed between an oil-side end cap 410 and a spring-side end cap 412. The spring 402 may be attached to the piston 404 which is configured d to slide towards and away from spring-side end cap 412 depending on a difference between a hydraulic pressure of the region indicated at 408 and that applied to piston 404 by spring 402. As shown, a piston wear ring 406 and a sealing element 414 may be concentrically disposed about the piston between the piston 404 and walls of the fluid chamber 400. The purpose of spring accumulator 606/608 is to store up energy—in the form of hydraulic pressure—originating from energizing of electric motor 302 (e.g., referring to FIGS. 1-3), to provide the actuation pressure needed to actuate a valve of a flowline 102 (e.g., referring to FIG. 1) when signaled by one of the various control packages.

Piston 404 is disposed within the fluid chamber 400 of the spring accumulator 606/608 and may linearly fluctuate along the length of the fluid chamber 400 by virtue of its attachment to spring 402. The piston 404 may be made of any suitable material such as aluminum. Piston 404 may have a bore diameter of about 5″. Alternatively, between 3″ and 8″, or any ranges therebetween, without limitation. A piston wear ring 406 may be concentrically disposed about piston 404. Piston wear ring 406 may reduce wear of the piston 404 over time. In examples, piston wear ring 406 may comprise any suitable material including, without limitation, Teflon (also known as polytetrafluoroethylene or PTFE), as well as rubber such as buna-n rubber, or combinations thereof, in some examples. Piston wear ring 406 may be impregnated with oil.

Moreover, a sealing element 414 may be likewise concentrically disposed about piston 404. In examples, sealing element 414 may be characterized as a “U-cup” or a “piston quad seal.” Sealing element 414 may comprise any suitable material including, without limitation, rubber such as buna-n rubber. Sealing element 414 prevents fluid from leaking out of spring accumulator and ensures pressurize isolation between the region indicated at 408 and the region housing spring 402.

Oil-side end cap 410 encloses the region indicated at 408 within fluid chamber 400 and forms part of spring accumulator 606/608. Oil-side end cap 410 may be made of any suitable material including, for example, aluminum. An aperture 424 may extend through oil-side end cap 410 to allow pressurized fluid from manifold block 308 to enter through aperture 424 and into region 408.

Spring-side end cap 412 likewise encloses the region of the fluid chamber 400 that contains spring 402. Spring-side end cap 412 may be made of any suitable material including, for example, aluminum. A position indication rod 416 may extend at least partially into fluid chamber 400 such as through spring 402 and may be coupled to piston 404. The position of piston 404 within fluid chamber 400 and thus the compression state of spring 402 may thus be determined by how far out position indication rod 416 extends from spring-side end cap 412. Position indication rod 416 may have a stud with chamfered edges, to be shown and described in FIG. 5.

Sealing element 418—like sealing element 414—is a sealing element that ensures the region indicated at 408 is pressure sealed. However, sealing element 418 is concentrically disposed about a portion of oil-side end cap 410 that extends at least partially into fluid chamber 400. In some examples, sealing element 418 may be characterized as an “oil-side end cap O-ring.” Sealing element 418 may comprise any suitable material including, without limitation, rubber such as buna-n rubber.

Gasket 420 is disposed between spring-side cap and the walls of fluid chamber 400. Gasket 420 may comprise any suitable gasket material including, for example, rubber such as buna-n rubber. Gasket 420 similarly serves to ensure pressure isolation of the region(s) disposed within the spring accumulator 606/608 from the outside. One or more fasteners 422 (e.g., screws, bolts, etc.) may be used to couple the various components of spring accumulator 606/608 together.

FIG. 5 shows position indication rod 416, as mentioned, in accordance with some examples of the present disclosure. As shown, position indication rod 416 may have a cylindrical body 500 configured d to extend at least partially through spring 402 (e.g., referring to FIG. 4). Further, position indication rod 416 may comprise a stud 502 which has, in some examples, a chamfered surface 504. Chamfered surface 504 may break the sharp edges that would otherwise be formed by stud 502, and may be chamfered by, e.g., about 45 degrees. Another chamfered surface 506 may exist at the planar surface formed at the transition between cylindrical body 500 and stud 502. In examples, position indication rod 416 may be characterized as a “linear motion threaded rod,” and may be coupled to piston 404.

Spring accumulator 606 (e.g., referring to FIG. 4) may be used in pumping system 100 (e.g., referring to FIG. 1), e.g., for low displacement motors. Alternatively, multiple spring accumulators 606/608 may be used, e.g., for high displacement motors. For example, another spring accumulator 608 may be located in any suitable location where it can be fluidically coupled to manifold block 308, such as on the side of the manifold block 308 opposite to spring accumulator 606 (e.g., referring to FIG. 3). In some examples, one or more spring accumulator may extend at least partially through manifold block 308.

In operation, as fluid is forced at high pressure into a region within fluid chamber 400 indicated at 408, spring 402 is compressed and linear movement is imparted to position indication rod 416. When it is desired to actuate an actuator 104 with pumping system 100 (e.g., referring to FIG. 1), e.g., to open or close a valve, hydraulic pressure stored within spring accumulator 606/608 may be discharged to cause the valve of a flowline 102 to change its position.

FIG. 6 illustrates a control circuit 600 for controlling the valve actuation pumping system 100 of FIGS. 1-4, in accordance with some examples of the present disclosure. As shown, the control circuit may comprise a hydraulic cylinder 108, spring accumulator(s) 606/608 (e.g., “JuicePaks”), hydraulic gear pump 612, solenoid valve 326, manual override 310, relief valve 602, needle valve 604, and check valve 610.

The overall function of control circuit 600 is to output pressurized hydraulic oil into hydraulic cylinder 306 to open/close a valve 104 (e.g., referring to FIGS. 1 and 2). This is accomplished by a closed-loop hydraulic system (e.g., pumping system 100 of FIG. 3). As shown, control circuit 600 (and thus pumping system 100, by extension) can be divided into two sides: a high pressure side schematically indicated at 614, and a low pressure side schematically indicated at 616. On the low pressure side, the majority of the fluid is stored in the spring accumulator(s) 706/708 and the rod side of hydraulic cylinder 306. Spring accumulator 706/708 maintain(s) the low pressure, e.g., via spring 402 and piston 404 (e.g., referring to FIG. 4). In examples, the low pressure side is analogous to a fluid reservoir in a non-closed loop system.

To actuate valve 104 (e.g., referring to FIGS. 1 and 2), hydraulic cylinder 306 is pressurized. This is accomplished by energizing solenoid valve 326 and turning gear pump 612 to draw fluid from the low pressure side to the high pressure side. Rotation of gear pump 612 is driven by electric motor 302 (e.g., referring to FIG. 3). De-energizing solenoid valve 326 may allow fluid to flow from the high pressure side to the low pressure side, and expansion of spring 402 (e.g., referring to FIG. 4) causes valve 104 (e.g., referring to FIGS. 1, 2) to close. Relief valve 602 may return fluid to the low pressure side if the high pressure side reaches above a threshold or a desired pressure. Manual override 310 (e.g., referring to FIG. 3) may be used to manually pump fluid from the low pressure side to the high pressure side to open valve 104 (e.g., referring to FIGS. 1, 2).

FIG. 7 illustrates hydraulic circuit 700. Needle valve 604 may thus be in an open position for motorized operation and closed while manually overriding (e.g., hand-pumping) pumping system 100 (e.g., referring to FIGS. 1-3). as follows. The overall function is to output pressurized hydraulic oil into an actuators cylinder to open/close a valve. This is accomplished hydraulic circuit 700. The majority of the fluid is stored in the spring accumulators and the rod side of the actuator cylinder. Spring accumulator maintain the low pressure via a spring driven piston. The low pressure side can be considered analogous to a fluid reservoir in a non-closed loop system.

To actuate the valve the actuator cylinder may be pressurized. This is accomplished by energizing the solenoid valve and turning the gear pump to draw fluid from the low-pressure side to the high-pressure side. The gear pump is spun via an electric motor. De-energizing the solenoid valve may allow fluid to flow from the high-pressure side to the low-pressure side, and the actuator spring causes the valve to close. Item is a relief valve that returns fluid to the low-pressure side if the high-pressure side reaches above the desired pressure. Handpump may be used to pump fluid from the low-pressure side to the high pressure side to open the valve. Needle valve must be open for motorized operation and closed while hand-pumping the system.

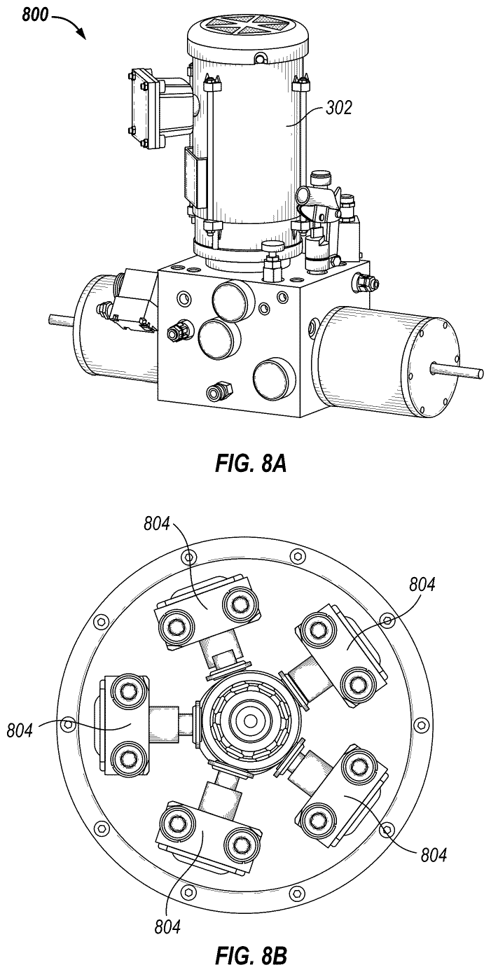

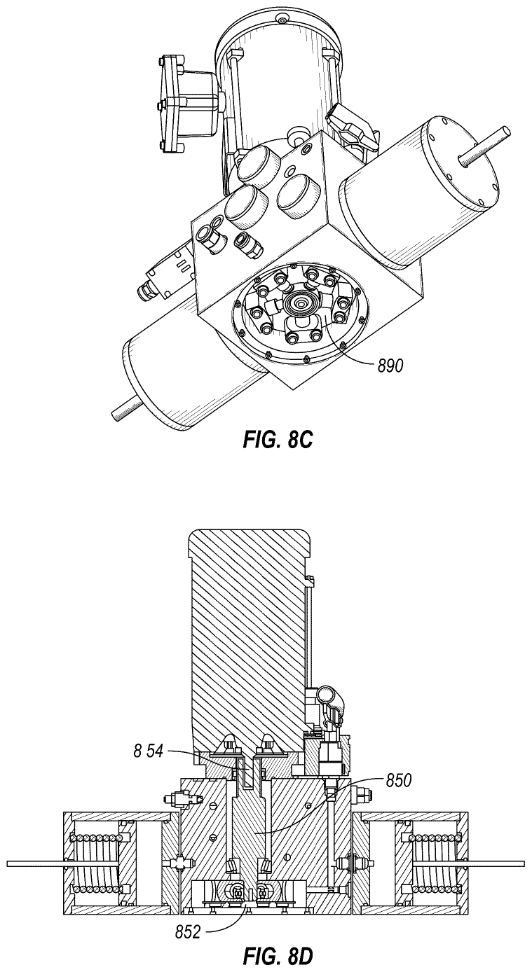

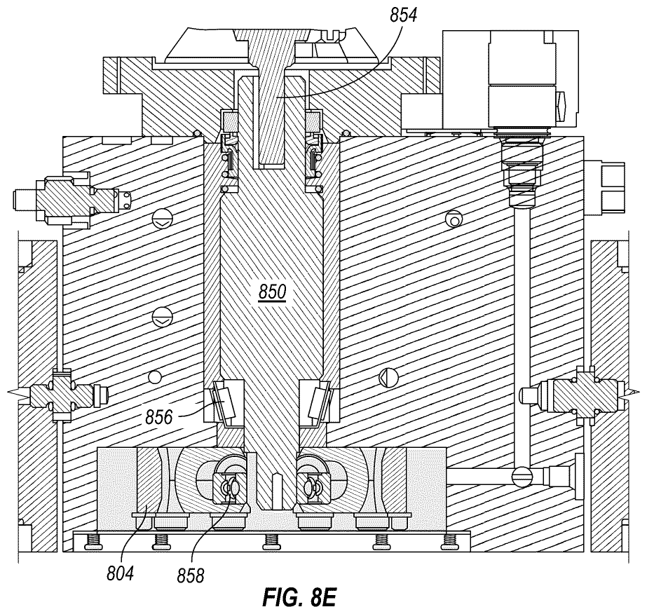

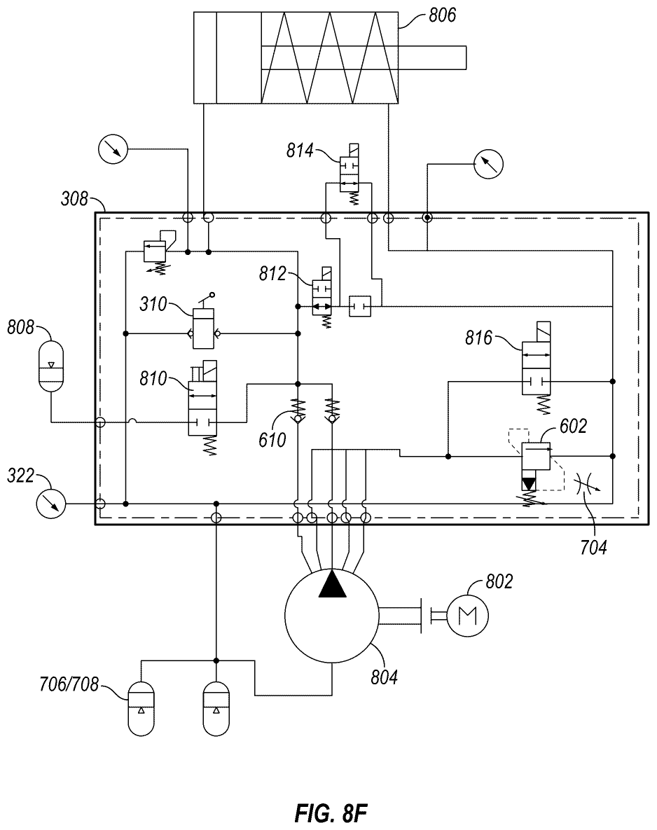

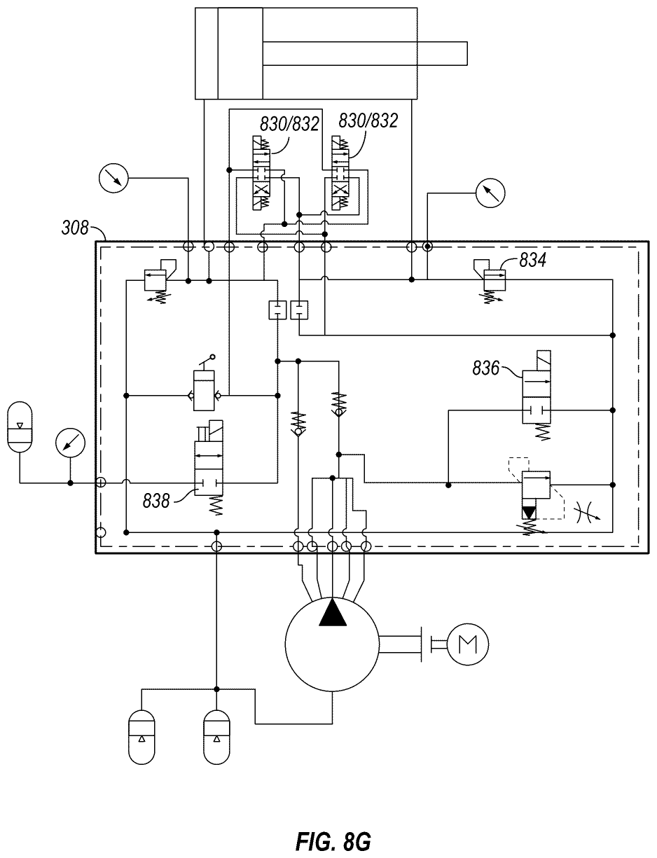

FIG. 8A illustrates multi-pump manifold block 800. Multi-pump manifold block 800 acts as an alternate to the gear pump version of the Newton Electro-Hydraulic (EH). A Newton EH with a multi-pump manifold block 800 may be in place of a gear-pump manifold block. In examples, the piston pump elements 804 may be coupled to electric motor 302 through an eccentric coupler extension that is slid over the motor shaft. FIG. 8B illustrates pump elements 804, centered with the electric motor shaft. FIG. 8C illustrates pump housing cavity 890. FIG. 8D illustrates shaft extension 850 has an electric bearing 852 on the end, which is eccentric to the electric motor shaft 854, so as electric motor 302 spins the eccentric bearing strokes each piston pump element once. FIG. 8E illustrates multi-pump manifold block 800 with bearing to carry shaft extension 856 and eccentric mounted bearing 858.

FIG. 8F illustrates, spring return (single acting) multi-pump circuit 840. Electric motor drive 802 one or more pump elements 804. All pump elements 804 initially flow to the hydraulic actuator cylinder 806. As pressure increases in the cylinder the electric motor will near its upper load limit. When the pressure reaches a point where the motor upper load limit has been reached solenoid valve 4 will be energized. This may allow for all but one of the pump element 804 to dump back to the low-pressure spring accumulators (e.g., referring to FIG. 4). This may reduce the motor load and allows the single remaining pump element that still leads to the hydraulic cylinder 108 (e.g., referring to FIG. 2) to achieve a higher pressure in the actuator cylinder 306 (e.g., referring to FIG. 3). The reduced flow rate to actuator cylinder 306 may allow for a finer position control as well. On the right, the light green is the low-pressure side of the hydraulic circuit (e.g., referring to FIG. 7). In examples, a path of flow from the pump element 804 to the actuator cylinder 806. Another path may be the flow from the other pump elements. Another path may be their return path to the low-pressure side, the orange path is their path to the high-pressure actuator cylinder 806.

Hydraulic handpump 310 may pull fluid from the low-pressure side into the actuator cylinder 806. Accumulator 1 808 may store pressurized fluid that may be released by actuating solenoid valve 1 810, allowing the fluid to flow the actuator cylinder 806. Handpump 310 or a motorized pump may be used to charge the accumulator. Solenoid valve 3 812 may be used to dump high-pressure fluid back the actuator back to the low-pressure side. Solenoid valve 2 814 and 3 816 may be optional redundant solenoid valve for the same function.

The function of the multipump circuit 840 is to allow modulating valve actuation position control. Modulating valve control refers to the ability to hold a valve at position, from 0% open to 100% open. Holding the valve at a specific position is a combination of speed and accuracy. When the valve position is far from the desired position speed is the priority, as it is desirable to achieve the desired position quickly. When the valve position is near to the desired position accuracy is important, as it is desirable for the actual valve position to align closely to the desired valve position.

To move the valve quickly the multi-pump hydraulic circuit design utilizes several piston pump elements to increase the flow rate to the valve actuator. When the valve position is near to the desired position, or a certain hydraulic pressure is reached, all but one of the pump elements will stop delivering fluid to the pressurized actuator cylinder. Instead, these pump elements will have their flow re-directed to the low-pressure spring accumulators. One pump element is left that is pumping to the valve actuator cylinder. This reduces the flow rate and allows a high pressure to be achieved in the actuator cylinder without overloading the electric motor. The reduced flow rate to the actuator slows the valve travel speed down, allowing for the valve to be stopped very close to the desired position. If the valve position drifts away from the desired position the single pump element may be used to re-adjust to the desired position without overshooting it.

FIG. 8G illustrates another example of multi-pump circuit with additional valves. In examples, multi-pump circuit with additional valves 844 may comprise solenoid valves 5/6 830/832, relief valve 834, solenoid valve 836, and/or solenoid valve 838.

It is to be understood that the present disclosure is not limited to particular devices or methods, which may, of course, vary. It is also to be understood that the terminology used herein is for the purpose of describing particular examples only and is not intended to be limiting. All numbers and ranges disclosed herein may vary by some amount. Whenever a numerical range with a lower limit and an upper limit is disclosed, any number and any comprised range falling within the range are specifically disclosed. Although individual examples are discussed herein, the invention covers all combinations of all those examples. As used herein, the singular forms “a”, “an”, and “the” comprise singular and plural referents unless the content clearly dictates otherwise. Furthermore, the word “may” is used throughout this application in a permissive sense (i.e., having the potential to, being able to), not in a mandatory sense (i.e., must). The term “comprise,” and derivations thereof, mean “including, but not limited to.” The term “coupled” means directly or indirectly connected. If there is any conflict in the usages of a word or term in this specification and one or more patent or other documents that may be incorporated herein by reference, the definitions that are consistent with this specification should be adopted for the purposes of understanding this invention.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any comprised range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

The scope of the present disclosure comprises any feature or combination of features disclosed herein (either explicitly or implicitly), or any generalization thereof, whether or not it mitigates any or all of the problems addressed herein. Various advantages of the present disclosure have been described herein, but examples may provide some, all, or none of such advantages, or may provide other advantages.

Improvements over the current implementations comprise a closed-loop, reservoir-less electro-hydraulic valve actuation system that integrates a spring accumulator and pump within a sealed housing to reduce contamination, maintenance, and nonproductive time while maintaining controlled valve operation. This is not shown in current examples because conventional electro-hydraulic valve actuators typically rely on open or semi-open hydraulic reservoirs and external components, whereas this system operates in a sealed, closed-loop configuration that integrates the pump, spring accumulator, and controls within a single housing, thereby reducing contamination pathways, maintenance requirements, and nonproductive time. As such improvements shown herein distinguish over current implementations and solve a current problem.

What is claimed is:

1. A system, comprising:
a housing;
a manifold block;
a motor in energetic communication with the manifold block; and
a spring accumulator in fluid communication with the manifold block.

2. The system of claim 1, wherein the manifold block, the motor, and the spring accumulator are all housed within the housing.

3. The system of claim 2, wherein the length of the housing is between 16″ and 40″.

4. The system of claim 2, width the width of the housing is between 16″ and 40″.

5. The system of claim 2, wherein the depth of the housing is between 8″ and 30″.

6. The system of claim 2, further comprising a motor starter box energetically coupled to the motor, a solenoid valve connected to the manifold block, a manual override connected to the manifold block, and a pressure switch, all disposed within the housing.

7. The system of claim 2, further comprising a control package for actuating electric motor.

8. The system of claim 7, wherein the control package is a touchscreen human machine interface (HMI) and/or a programmable controller configured to replace multiple timers, relays, and/or counters.

9. The system of claim 1, wherein the manifold block is designed for high efficiency power transmission.

10. The system of claim 1, further comprising a pump coupled to the manifold block.

11. The system of claim 10, wherein the pump is a gear pump.

12. The system of claim 10 wherein the pump is a multi-pump manifold block.

13. The system of claim 12, wherein piston pump elements are coupled to the motor through an eccentric coupler extension that is slid over a motor shaft.

14. A method comprising:
actuating a pumping system comprising:
a housing;
a manifold block;
a motor in energetic communication with the manifold block; and
a spring accumulator in fluid communication with the manifold block.

15. The method of claim 14, wherein the manifold block, the motor, and the spring accumulator are all housed within the housing, the length of the housing is between 16″ and 40″, the width of the housing is between 16″ and 40″, and the depth of the housing is between 8″ and 30″.

16. The method of claim 15, wherein a motor starter box energetically is coupled to the motor, a solenoid valve connected to the manifold block, a manual override connected to the manifold block, and a pressure switch, all disposed within the housing.

17. The method of claim 16, wherein a control package is for actuating electric motor.

18. The method of claim 17, wherein the control package is a touchscreen human machine interface (HMI) and/or a programmable controller configured to replace multiple timers, relays, and/or counters.

19. The method of claim 14, wherein the manifold block is designed for high efficiency power transmission.

20. The method of claim 14, wherein actuating is performed via a gear pump or a multi-pump manifold block.
